(19) United States
(12) Patent Application Publication
(10) Pub. No.: US 2015/0122815 A1
(43) Pub. Date: May 7, 2015

(54) ENHANCED PERFORMANCE COMPOSITE MATERIALS FOR SPECIALTY USES AND METHODS OF MAKING THE SAME

(71) Applicant: TEX-TECH INDUSTRIES, INC., Portland, ME (US)

(72) Inventor: Courtney Musciano, Portland, ME (US)

(21) Appl. No.: 14/070,007

(22) Filed: Nov. 1, 2013

(51) Int. Cl. B65D 90/00; D04H 1/46; B29C 70/02; B32B 5/26

(52) U.S. Cl. CPC B65D 90/008; B32B 5/26; D04H 1/46; B29C 70/028
USPC 220/200; 442/240; 442/242; 442/276; 28/103; 264/101

(57) ABSTRACT

The invention provides composite materials, methods for making the same, and a containment structure incorporating the materials. A composite having a rigid structure includes first and second woven layers and a non-woven layer having first and second faces, first face fibers being attached to and mechanically entangled with fibers of the first woven layer and second face fibers being attached to and mechanically entangled with fibers of the second woven layer to form an integral material. A composite having a flexible structure includes a woven layer and a fire resistant non-woven layer having a first face, the first face including fibers being attached to and mechanically entangled with fibers of the woven layer to form an integral material. The woven layer includes an aramid and the non-woven layer includes a fiber blend. The integral materials are molded to form respective rigid and fire resistant, flexible composite materials.

### STATEMENT REGARDING FEDERALLY SPONSORED RESEARCH OR DEVELOPMENT

Not applicable.

### BACKGROUND OF THE INVENTION

1. Field of the Invention

The invention relates to enhanced performance composite materials for specialty uses and methods for making the same. The enhanced composite materials have utility in the manufacture of specialty products such as, for example air cargo containers.

2. Description of the prior art

Conventional containers for specialty uses, such as, for example, air cargo containment, require lightweight materials, durability, strength, adaptability for different cargo configurations, maximum interior space for containment, and preferably resistance to fire, heat conduction, moisture and delamination.

Conventional air cargo containers have been made of aluminum alloy. Aluminum structures are lighter than other metals, but damage easily with rough handling, conduct heat, and readily permit condensation. With respect to fire resistance, such materials do not burn, but at temperatures exceeding 1200° F., they melt and cease to act as a flame barrier.

In an effort to address these drawbacks, containers formed of composite materials have been investigated. Some of these structures include honeycomb composite materials which are advantageously lightweight. Unfortunately, honeycomb composite structures are not as strong as aluminum and cannot hold the equivalent weights of aluminum structures. Other non-metal alternatives which have been investigated include plastic, fiberglass panels, and/or aramid composite materials. Generally, the different layers of such structures are held together with some type of seal or adhesive, such as, for example, a resin matrix. Structures composed of such materials are generally lightweight and strong, but they are not fire resistant. In the air cargo industry in particular, there is a demand for fire resistant materials where the transportation of fire-hazardous materials has led to fires and air plane crashes in the past. In addition, the layers of composite materials adhered to one another through seals or adhesives can delaminate upon exposure to heat or flame. Further, some of these composite materials include foam cores whose thicknesses compromise the available interior containment space in a given structure.

In one example of a structure formed of composite materials, publication WO 2013/101529 discusses containers where the sides, rear, floor, roof and perhaps the door panel of the container are constructed of sandwich structures each including a skin adhered by, for example, a resin matrix, to either side of a foam core. The publication teaches that the insulation properties of the core protect the skin on the “non-fire” side. The publication teaches that the skins are composed of fibers which extend completely through the sandwich structures and are folded over the outside structural surfaces thereby acting as staples to hold the structure together and to help prevent delamination. Although the extension and folding over of the fibers may contribute to securing the layers, the fibers of each of the separate layers are in no way mechanically entangled with one another. Further, the resin matrix which holds the structure together can fail as a result of exposure to heat or flame, as discussed above.

Accordingly, there is a need for lightweight, strong and durable, heat resistant specialty structures which will not delaminate upon exposure to heat or flame.

### BRIEF SUMMARY OF THE INVENTION

According to the present invention, high performance composite materials and methods for making the same are provided. In one aspect, a method of making a composite material having a rigid structure includes inserting at least one non-woven substrate layer having a first face and a second face in between at least a first woven substrate layer and at least a second woven substrate layer; mechanically entangling fibers of the non-woven substrate layer with fibers of the first face of the first woven substrate layer and fibers of the second face of the woven substrate layer to form an integral material; and molding the integral material into a rigid composite material. In one embodiment, the molding step includes impregnating the integral material with an impregnating resin to form a resin-impregnated integral material; and treating the resin-impregnated integral material to form the rigid composite material. In other embodiments, the step of impregnating includes infusing, with or without heat, the impregnating resin into the integral material to form the resin-impregnated integral material. In yet another embodiment, the step of infusing the impregnating resin includes pumping the impregnating resin into the integral material under vacuum.

In further embodiments, the step of impregnating includes applying at least once the impregnating resin to the integral material by pouring the impregnating resin to cover the integral material, dipping the integral material into a bath of the impregnating resin to submerge the integral material, or coating the integral material to cover the integral material with the impregnating resin, and combinations thereof.

In other embodiments, the step of impregnating includes pulling the integral material and the impregnating resin through a die and/or asserting pressure to force the impregnating resin to soak more deeply into the integral material.

In another embodiment, the step of treating the resin-impregnated integral material includes curing the resin-impregnated integral material in a single stage to form the rigid composite material. An alternative embodiment includes curing the resin-impregnated integral material to an intermediary stage to form an intermediary stage resin-impregnated integral material; forming the intermediary stage resin-impregnated integral material into a shape; and curing the shaped intermediary stage integral material to form the rigid composite material.

In yet another embodiment, the step of mechanically entangling further includes needle punching. In a further embodiment, the method includes adapting the impregnating resin for fire resistance.

The invention provides in another aspect a material having a rigid structure including at least a first and a second woven substrate layer and at least one non-woven substrate layer having a first face and a second face, fibers of the first face being attached to and mechanically entangled with fibers of the first woven substrate layer and fibers of the second face being attached to and mechanically entangled with fibers of the second woven substrate layer, to form an integral material; wherein the integral material is molded to form a rigid composite material.

In one embodiment, at least one of the woven substrate layers includes fibers of a type selected from the group consisting of an aramid, a fiberglass and a basalt. In another embodiment, at least one of the woven substrate layers includes at least two woven substrate layers woven into a single layer to form a double cloth.

In a further embodiment, the non-woven substrate layer includes fibers of a type selected from the group consisting of an aramid, a pre-oxidated polyacrylonitrile, a BelCoTex®, a fiberglass, and a modacrylic. In yet a further embodiment, the non-woven substrate layer includes a fiber blend of at least two different types of fibers. In another embodiment, the nonwoven layer is mechanically entangled with the woven substrate layers by needle punching.

In an additional embodiment, the rigid composite does not delaminate when exposed to a temperature of at least 1550° F. at a minimum for up to 12 seconds.

The invention further provides in another embodiment that the integral material is molded wherein the integral material is impregnated with a resin to form a resin-impregnated integral material; and wherein the resin-impregnated integral material is treated to form the rigid composite material.

In yet another embodiment, the impregnating resin is adapted for fire resistance. In other embodiments, the impregnating resin is selected from the group consisting of an acrylic resin, a polyester resin, a vinyl ester resin, a polyurethane resin, an epoxy resin, and a phenolic epoxy resin.

In a further embodiment, the resin-impregnated integral material is treated by curing to form the rigid composite material.

In another aspect, the invention provides a composite material having a flexible structure including at least one woven substrate layer and at least one fire resistant non-woven substrate layer having a first face, the first face including fibers being attached to and mechanically entangled with fibers of the woven substrate layer to form an integral material; wherein the woven substrate layer comprises an aramid; wherein the fire resistant non-woven substrate layer comprises a fiber blend; and wherein integral material is molded to form a fire resistant, flexible composite material.

In one embodiment, the flexible composite material further includes a fire resistant coating. In another embodiment, the fiber blend includes at least one type of fiber selected from the group consisting of an aramid, a fiberglass, a pre-oxidated polyacrylonitrile, a BelCoTex®, and a modacrylic. In yet another embodiment, the flexible composite material can be folded in on itself.

In another embodiment, the invention provides a structure for containment which includes a plurality of non-door panels wherein each non-door panel includes the rigid composite material of the invention, and a door panel including the flexible composite material of the invention; and wherein the non-door panel and the door panel are assembled to form a containment structure enclosing an interior space capable of being sealed and unsealed using the door panel.

In another aspect, the invention provides a structure for containment. The structure includes non-door panels wherein each non-door panel includes at least a first and a second woven substrate layer and at least one non-woven substrate layer having a first face and a second face, fibers of the first face being attached to and mechanically entangled with the fibers of the first woven substrate layer and the fibers of the second face being attached to and mechanically entangled with the fibers of the second woven substrate layer, to form an integral non-door panel material; and wherein the integral non-door panel material is molded to form a rigid composite non-door panel. The structure for containment further includes a door panel including at least one woven substrate door panel layer and at least one non-woven substrate door panel layer having a first face, the first face including fibers being attached to and mechanically entangled with a fibers of the woven substrate door panel layer to form an integral door panel material; wherein the integral door panel material is molded to form a flexible composite door panel; and wherein the rigid composite non-door panels and the flexible composite door panel are assembled to form a containment structure enclosing an interior space capable of being sealed and unsealed using the flexible composite door panel.

Further features of the present invention will become apparent from the following description of embodiments thereof, given by way of example only, with reference to the accompanying drawings, in which:

### BRIEF DESCRIPTION OF THE SEVERAL VIEWS OF THE DRAWINGS

FIG. 1 is a profile view of a rigid composite material according to an embodiment of the invention;

FIG. 2 shows the steps of a method for making a rigid composite material according to an embodiment of the invention;

FIG. 3 is profile view of an integral material including a fire-resistant non-woven layer and a woven layer according to an embodiment of the invention;

FIG. 4 is a side view of a fire resistant, flexible composite material according to an embodiment of the invention;

FIG. 5 is a profile view of a fire resistant, flexible composite material according to an embodiment of the invention;

FIG. 6 shows the steps of a method for making a fire resistant, flexible composite material according to an embodiment of the invention; and

FIG. 7(a-b) are profile views of a containment structure according to an embodiment of the invention.

### DETAILED DESCRIPTION OF THE INVENTION

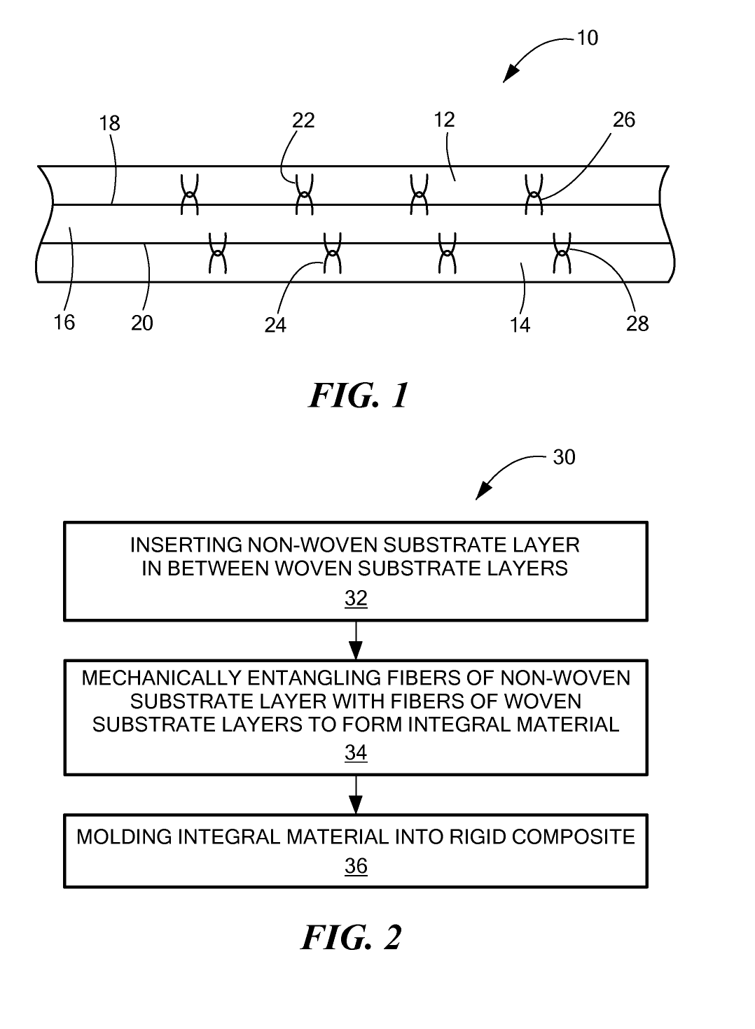

The rigid composite material of the present invention is shown in the drawings in profile view in FIG. 1. At least one non-woven substrate layer 16 is sandwiched between at least one first woven substrate layer 12 and at least one second woven substrate layer 14. The sandwiching of a non-woven substrate layer 16 in between the woven substrate layers 12 and 14 provides dimensional stability to the structure. Although non-woven substrate layer 16 is shown as a single layer, the non-woven substrate layer 16 may consist of multiple layers. Such layers may be stacked one upon another. Similarly, although the woven substrate layers 12 and 14 are illustrated as single layers, each of these layers may include multiple layers and such multiple layers may be stacked. Further, at least two woven layers can be woven into a single layer to form a double cloth.

The non-woven substrate layer 16 is sandwiched between the woven substrate layers 12 and 14 such that a first face 18 of the non-woven substrate layer 16 abuts the first fiber substrate layer 12 and a second face 20 of the non-woven substrate layer 16 abuts the second woven substrate layer 14. The non-woven and woven substrate layers are aligned together. The woven substrate layers 12 and 14 include a plurality of fibers 22 and 24, respectively, which can be woven into a fabric. The non-woven substrate layer 16 includes a plurality of fibers 26 and 28 which can be blended and carded to form a non-woven fiber blend in the non-woven substrate layer 16.

In the present invention, in contrast to conventional materials, the fibers 26 at the first face 18 of the non-woven substrate layer 16 are mechanically entangled with the fibers 22 of the first woven substrate layer 12 and the fibers 28 at the second face 20 of the non-woven substrate layer 16 are mechanically entangled with the fibers 24 at the second face 20 of the second woven substrate layer 14, substantially locking the three layers together to form an integral material. Qualities present in the non-woven fiber substrate layer 16 are thereby imparted to the outer woven-substrate layers 12 and 14.

The mechanical entanglement of the nonwoven and the first and second woven substrate layers is varied according to the material selected for the non-woven and the first and second woven substrate layers of the present invention. Different methods of mechanical entanglement known to those of ordinary skill in the art such as, for example, needle punching, hydroentanglement, the use of water or air jets, press felting or wet processing, and the like can be used for mechanical entanglement of fibers in the materials and methods of the present invention.

In a preferred embodiment, the mechanical entanglement is provided through needle punching. The term needle punching as used herein also is also referred to as needle felting or needling. The term needle punching used herein encompasses all these terms. The variation of the needle punching process can include the amount of needle punches per unit area, the depth of those punches and/or the types of needles used. These settings are varied according to the desired end use or application of the composite material. The process of mechanical entanglement increases interlaminar sheer strength and flexibility of the material over conventional materials which rely on adhesives for attaching various layers.

For example, with reference to FIG. 1, the mechanical entanglement is accomplished by needle punching the first 12 and the second 14 woven substrate layers and the non-woven substrate layer 16 together. Hundreds of needles pass through the layers such that the fibers 26 at the first face 18 of the non-woven substrate layer 16 are pulled through the fibers 22 of the outer first woven substrate layer 12 and the fibers 28 at the second face 20 of the non-woven substrate layer 16 are pulled through the fibers 24 of the outer woven substrate layers 14.

After mechanical entanglement, optionally, the formed integral material of the present invention can be further consolidated by calendaring the needled material through nip rolls. Calendaring in a nip roll further densifies the material and reduces the overall thickness profile of the material. Calendaring is the process of applying pressure, and sometimes heat, to a material for further densification.

Once formed, the integral material of this aspect of the invention is subsequently molded to form a rigid composite material. The process of molding the integral material is more fully described below in the detailed description of the method of making the rigid composite materials of the invention.

The non-woven and woven materials are selected on the basis of the desired end properties of the final composite material and cost. For example, Kevlar® fibers can be selected to strengthen the composite material. Pre-oxidated polyactrylonitrile and BelCoTex® fibers can be selected for fire resistance. Modacrylic fibers can be selected for their relatively fire resistant properties and further their abilities to extinguish the afterglow or burn of a fire.

With respect to the present invention's rigid composite materials and methods for making the same, the non-woven substrate layer 16 can include a blend of at least two fibers 26, 28 of more than one type. The fibers 26, 28 can include, for example, aramid, pre-oxidated polyactrylonitrile, BelCoTex®, fiberglass and modacrylic fibers, and combinations thereof. For the purposes of this invention, the term “aramid” is understood to include mono-aramid, meta-aramid, poly-aramid, para-aramid, and/or para-polyaramid fibers. Exemplary aramid fibers for use with the non-woven substrate layer 16 of the invention include Twaron® and Kevlar® fibers.

With respect to the present invention's rigid composite materials and methods for making the same, the woven substrate layers 12 and 14 can include aramid, fiberglass and basalt fibers. Like the non-woven substrate layer, the woven substrate layers 12 and 14 can include exemplary aramid fibers such as Twaron® and Kevlar® fibers.

The shear properties of the composite materials of the present invention are measured by standard measurement techniques known to those of ordinary skill in the art, such as, for example, the Standard Test Method for Shear Properties of Composite Materials by V-Notched Rail Shear Method, ASTM D-7078/D7087M-12. The rigid composite materials of the present invention show a shear property measurement from about 2 ksi to about 30 ksi, and more preferably from about 5 ksi to about 20 ksi, and more preferably from about 5 ksi to about 15 ksi.

The tensile properties of the composite materials of the present invention are also measured by standard measurement techniques known to those of ordinary skill in the art, such as, for example, the Standard Test Method for Tensile Properties of Polymer Matrix Composite Materials, ASTM D-3039/D3039M-08. The rigid composite materials of the present invention show a tensile property measurement from about 10 ksi to about 200 ksi, and more preferably from about 40 ksi to about 80 ksi, and more preferably from about 50 ksi to about 70 ksi.

In addition, the flame resistance properties of the composite materials of the present invention are measured by standard measurement techniques known to those of ordinary skill in the art, such as, for example, the Standard Test Method for Flame Resistance of Textiles (Vertical Test) 1, ASTM D-6413-99. The rigid composite materials of the present invention will self-extinguish from about 0 seconds to about 30 seconds, and more preferably from about 0 seconds to about 10 seconds, and most preferably from about 0 seconds to about 2 seconds. The resistance to delamination of the composite materials of the present invention is also measured by standard measurement techniques known to those of ordinary skill in the art. For example, the rigid composite material did not de-laminate when exposed to a 1600° F.+/−50° F. flame for about 12 seconds, and preferably did not delaminate when exposed to such a flame up to 60 seconds.

The weight and thickness of the composite materials of the present invention can vary depending on the type and number of nonwoven and woven substrate layers selected, the amount of nonwoven and woven fibers used in the respective nonwoven and woven substrate layers, the degree of mechanical entanglement of the fibers, and the desired end use of the integral materials. Weights of the rigid composite material of the present invention can vary from about 5 to about 80 ounces per square yard, and more preferably from about 10 to about 60 ounces per square yard, and most preferably from about 15 to about 40 ounces per square yard. Thicknesses of the rigid composite material of the present invention can vary from about 0.010 inches to about 0.100 inches and more preferably from about 0.010 inches to about 0.080 inches, and most preferably from about 0.020 inches to about 0.070 inches.

Due to the increased performance of the formed composite materials of the invention, less material can be used to achieve equivalent performance making the end products lighter weight, more flexible, and more durable compared to conventional processing.

In another aspect, the invention provides a method of making a composite material having a rigid structure. The steps of the method 30 are illustrated in FIG. 2 according to an embodiment of the invention. In step 32, a non-woven layer having a first face and a second face is inserted in between at least a first woven substrate layer and at least a second woven substrate layer. In step 34, the fibers of the non-woven layer are mechanically entangled with the fibers of the woven layers, as discussed above, to form an integral material. The integral material is then molded in step 36 to form a rigid composite material.

In one embodiment, the molding step includes impregnating the integral material with an impregnating resin to form a resin-impregnated integral material. The resin-impregnated integral material is then treated to form a rigid composite material.

The integral material may be impregnated with resin according to different processes known to those of ordinary skill in the art. For example, the resin can be poured over the integral material at least once to cover the integral material. In another method, the integral can be dipped or pulled at least once into a resin bath to submerge the integral material. In yet another method, the resin can be coated onto the integral material using a brush or other type of coating tool. Pressure can also be applied during or following these impregnation processes to force the resin to soak more deeply into the integral material. For example, a knife over coating process can be used where after the resin is applied to the integral material, the integral material travels on top of a roll, and a knife or other type tool is used to apply pressure to push the resin into the material and to scrape excess resin from the material surface. In another example, a squeeze roll process can be used where after application of the resin, the material is pulled through two large rolls sitting on top of one another and the rolls provide pressure to force the resin to soak more deeply into the material.

In one embodiment, a resin transfer molding (RTM) process is used to infuse the resin into the integral material. In the RTM process, the integral material is contained in a die or mold. The impregnating resin is then infused into the integral material and the resin substantially pulls itself through the integral material. Optionally, heat can be used to assist the infusion process. The RTM process is particularly effective for thin, low-viscosity resins and/or porous integral materials where the resin flows through the integral material relatively easily.

In another embodiment, a vacuum assisted resin transfer molding (VARTM) process is used to infuse the impregnating resin integral material by pumping the impregnating resin into the integral material under vacuum. Heat and/or additional pressure can be used to assist the (VARTM) process. Such a method of resin infusion is preferable for thicker resins and/or denser integral materials.

In another embodiment, the step of impregnating the resin into the integral material can include a pultrusion process. In such a process, the integral material and the resin are simultaneously pulled through a stencil, die, mold or other shaping device. The resin-impregnated integral material is then pulled out as a solid material in the desired shape and cured to form the rigid composite material.

Impregnation resins will be selected based on the desired end properties of the composite materials of the invention. Exemplary resins which can be used in the present invention include acrylic, polyester, vinyl ester, polyurethane, epoxy, and phenolic epoxy resins. The resins used in the rigid composite materials and methods further can be adapted for fire resistance.

Once impregnated, the resin-impregnated integral material can then be treated through curing to form the rigid composite.

Curing can take place in one or more stages. For example, in one embodiment, the resin-impregnated integral material is cured to a single or A-stage to form a single or A-stage resin-impregnated integral material which thereby forms the rigid composite. In another embodiment, the resin-impregnated integral material is cured to an intermediary or B-stage resin-impregnated material. This material can then be formed into a desired shape. Subsequently, the shaped intermediary or B-stage impregnated material can be cured further to a final or A-stage to form a final or A-stage resin-impregnated integral material thereby forming the rigid composite material.

In other embodiments, the method of the invention can include more than two curing stages. The number of curing stages, and the temperature, duration and conditions of the curing are selected according to the desired end properties of the composite material, such as, for example, the desired stiffness and the amount and type of resin of the material. For example, one-stage curing processes can result in composite materials with higher resin content than those of multiple stage curing processes. In contrast, the multiple stage curing processes can produce composite materials with a lower resin content which possibly can possibly be more flexible and potentially stronger than the single stage cured composite materials.

With respect to the rigid composite material of the present invention, curing is conducted at a temperature range from about 50° F. to about 1500° F., and more preferably from about 100° F. to about 700° F., and most preferably from about 200° F. to about 550° F. The curing of the rigid composite materials of the invention is conducted over a time frame from about 1 minute to about 24 hours, and more preferably from about 15 minutes to about 8 hours.

In the materials and the methods of the invention, the fibers in the woven and non-woven layers can be selected for fire resistance. In addition, the impregnating resin can be adapted for fire resistance according to methods known to those of ordinary skill in the art. For example, solvents, chemicals and/or fillers can be added to the impregnating resin to impart fire resistance. Alumina trihydrate (ATH) is non-limiting example of a filler that can be used in the present invention to adapt the resin to impart fire resistance.

The relative light weight, thinness, strength, and flame and delamination resistance of the rigid composites of the present invention make them suitable for specialty uses requiring strong, lightweight, and fire resistant panels, walls, ceilings, and/or floors. Non-limiting examples of such specialty uses include air cargo containers, modular laboratories and/or wall or other structural panels for use in light rail trains or similar transportation applications.

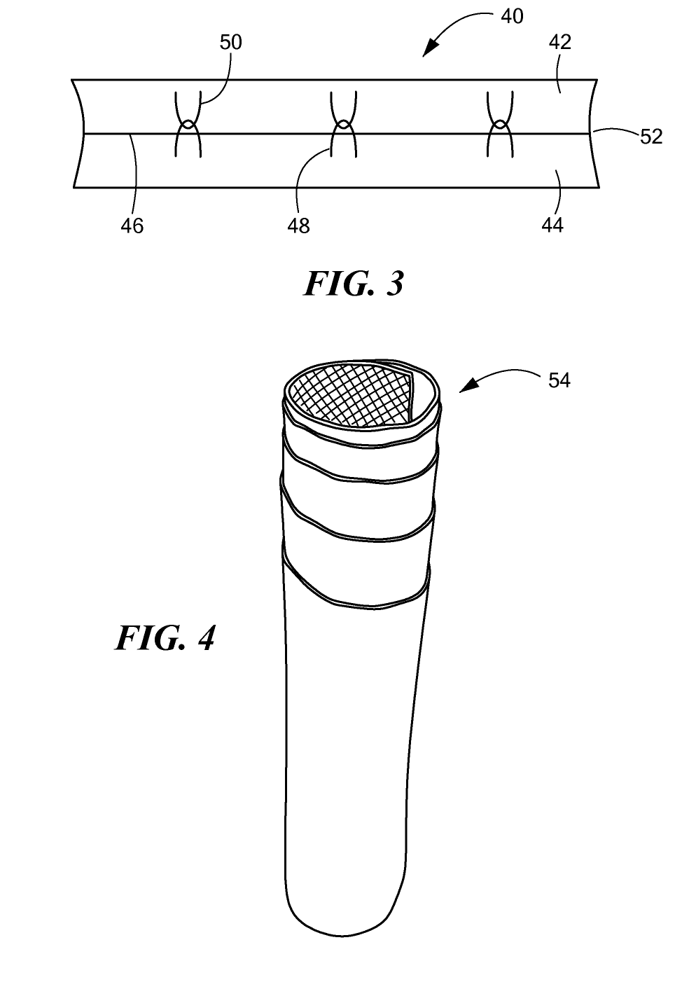

In yet another aspect, the invention provides a composite material having a flexible structure. Referring to FIG. 3, the invention provides a material 40 including a woven substrate layer which abuts and is aligned with a fire resistant non-woven substrate layer 44. The fibers 48 of the fire resistant non-woven substrate layer 44 are mechanically entangled with the fibers 50 of the woven substrate layer 42 to form an integral material 52. The integral material 52 is molded to form a fire resistant, flexible composite material. The woven substrate layer includes an aramid, and the fire resistant non-woven substrate layer includes a fiber blend. In a preferable embodiment, the flexible composite material is sufficiently flexible to roll up on around itself as shown by the exemplary flexible composite material 54 in FIG. 4.

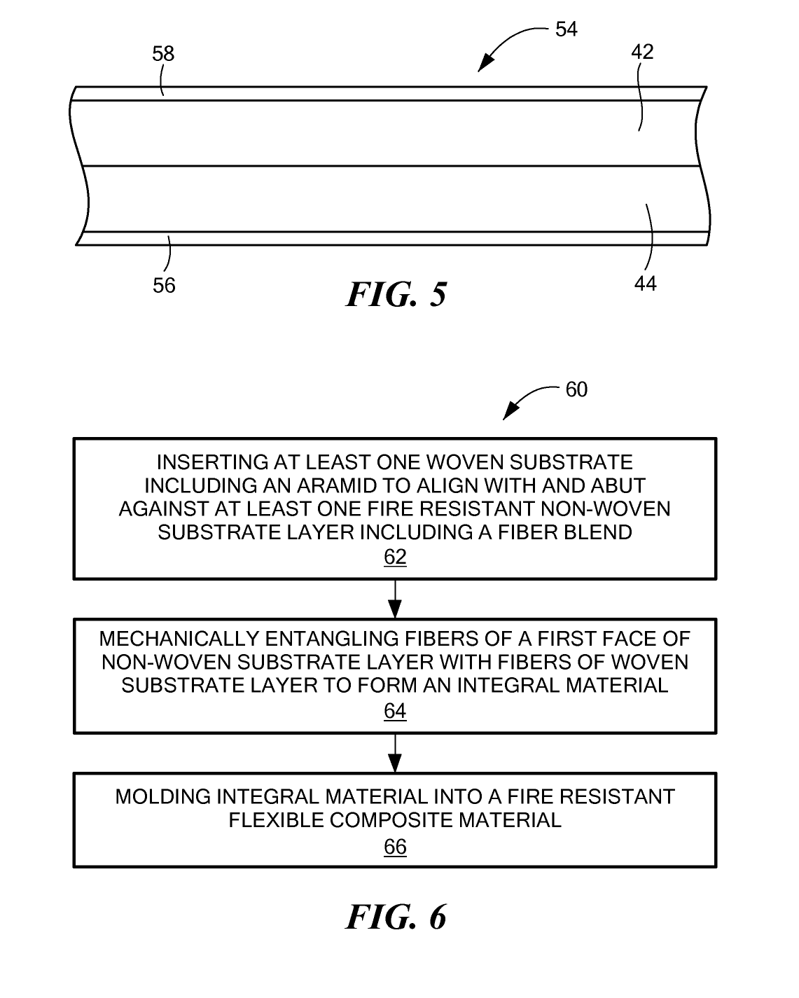

The fiber blend of the flexible composite material 54 can include at least one of a pre-oxidated polyacrylonitrile, an aramid, a fiberglass, a BelCoTex® and a modacrylic fiber. In addition, the flexible composite material 54 of the present invention can include a fire resistant coating 58 on the first woven substrate layer 42 and/or a fire resistant coating 56 on the non-woven substrate layer 44, as shown in FIG. 5.

The woven substrate layer 42 and the non-woven substrate layer of the flexible composite material 54 of the present invention are each shown as single layers in FIG. 5, but each of these layers can consist of multiple layers and such layers can be stacked. Accordingly, the weight and thickness of the flexible composite material 54 of the present invention can vary depending the number as well as type of layers and fibers of the non-woven and woven substrate layers, and with respect to thickness, the degree of mechanical entanglement of the fibers. Preferably, flexible composite material 54 has a weight measured from about 5 ounces per square yard to about 80 ounces per square yard, and more preferably from about 5 ounces per square yard to about 40 ounces per square yard, and most preferably from about 5 ounces per square yard to about 20 ounces per square yard. The thickness of the flexible composite material 54 ranges from about 0.010 inches to about 0.100 inches, and more preferably from about 0.010 inches to about 0.070 inches, and most preferably from about 0.010 inches to about 0.050 inches.

The woven 42 and non-woven fire-resistant 44 substrate layers of the flexible composite material 54 of the invention can be molded using the similar methods to those described above with respect to the rigid composite material of the present invention. Accordingly, the impregnation resins and method described above with respect to the rigid composite materials of the invention can be used with the flexible composite materials of the invention. The resins used can be further adapted for fire resistance. The selection of resins and impregnation resins can depend upon the desired properties of the resulting fire resistant, flexible composite material.

Similarly, the curing methods described above with respect to the rigid composite materials of the invention can be used with the fire resistant, flexible composite materials of the invention. The number of curing stages, and the temperature, duration and conditions of the curing can be selected according to the desired end properties of the flexible composite material 54.

The tensile and flame resistance properties of the fire resistant, flexible composite material 54 are measured using the same standards discussed above with respect to the rigid composite materials of the invention. The fire resistant, flexible composite material 54 has tensile properties measured from about 10 ksi to about 200 ksi, and more preferably from about 30 ksi to about 80 ksi, and most preferably from about 50 ksi to about 70 ksi. The fire resistant, flexible composite material 54 of the present invention will self-extinguish from about 0 seconds to about 30 seconds, and more preferably from about 0 seconds to about 10 seconds, and most preferably from about 0 seconds to about 2 seconds.

The resistance to delamination of the fire resistant, flexible composite material 54 of the present invention is also measured by the standard measurement techniques know to those of ordinary skill in the art discussed above with respect to the rigid composite of the invention. For example, the flexible composite material 54 of the invention does not de-laminate when exposed to a 1600° F.+/−50° F. flame for about 12 seconds, and preferably does not delaminate when exposed to such a flame up to 60 seconds.

The relative light weight, thinness, flexibility, and flame and delamination resistance of the fire resistant, flexible composite material 54 make this material ideally suitable for specialty uses, such as, for example, a door for an air cargo container.

In another aspect of the invention, the invention also provides a method 60 of making a composite material having a flexible structure, as shown in FIG. 6. The method provides a step 62 of inserting at least one woven substrate layer to align with and abut against at least one fire resistant non-woven substrate layer. The method next provides a step 64 of mechanically entangling the fibers of a first face of the fire resistant non-woven substrate layer with fibers of the woven substrate layer to form an integral material. The following step 66 includes molding the integral material to form a fire resistant, flexible composite material. The woven substrate layer includes an aramid. The fire resistant non-woven substrate layer includes a fiber blend. In an embodiment of this method of the invention, the fiber blend includes at least one type of fiber selected from the group consisting of a pre-oxidated polyacrylonitrile, an aramid, a fiberglass, a BelCoTex®, and a modacrylic. In another embodiment of this aspect of the invention, the method includes a step of applying a fire resistant coating to the flexible composite material. In yet another embodiment, this method of the invention includes the flexible composite material having flexibility such that the flexible composite material can be folded in on itself.

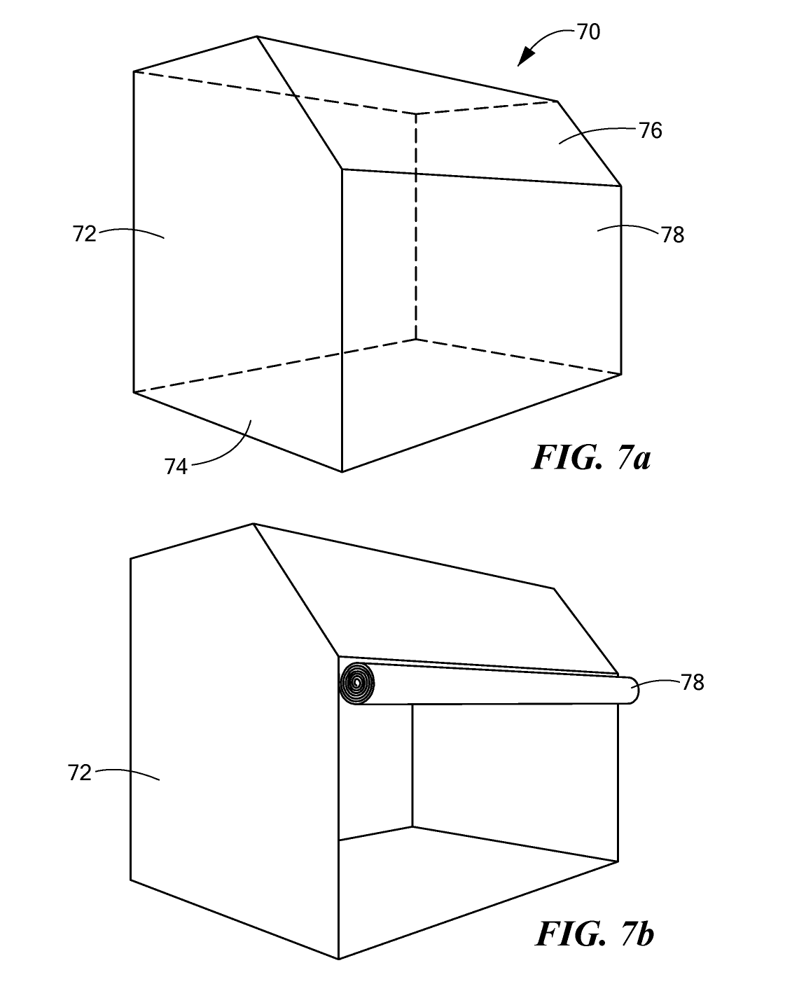

In another aspect, the invention provides an exemplary containment structure 70 which incorporates the rigid and flexible composite materials of the invention, as shown in FIG. 7a-b. FIG. 7a shows the structure 70 includes rigid composite walls 72, floor 74, and roof 76 wherein at least one of the walls 72, floor 74 or roof 76 includes a non-door panel which in turn includes at least a first and a second woven substrate layer and at least one non-woven substrate layer having a first face and a second face. Fibers of the first face are attached to and mechanically entangled with the fibers of the first woven substrate layer and fibers of the second face are attached to and mechanically entangled with fibers of the second woven substrate layer, to form an integral non-door panel material. The integral non-door panel material is molded thereby forming a rigid composite non-door panel.

The containment structure also includes a door panel 78. The door panel 78 includes at least one woven substrate door panel layer and at least non-woven substrate door panel layer having a first face. The first face is attached to and mechanically entangled with fibers of the woven substrate door panel layer to form an integral door panel material. The integral door panel material is molded thereby forming a flexible composite door panel. The rigid composite non-door panels and the flexible composite door panel are assembled to form a containment structure enclosing an interior space capable of being sealed and unsealed using the flexible composite door panel. FIG. 7b shows the flexible composite door panel 78 of the rigid containment structure 70 being able to fold in on itself.

The following examples demonstrate the invention's composite materials and methods for making the same.

### EXAMPLE 1

An exemplary rigid composite material according to the invention was prepared by placing a non-woven material (which may be manufactured, for example, by dry laid carding and mechanical needling) having an areal weight of about 7.5 oz./sq. yd. (254 g/m²) at the inlet side of a needlepunch loom on an automatic roll feed system timed to feed the material at the same rate as the machine speed. The nonwoven material was situated on a layer of woven material on the inlet side of the needlepunch loom. The leading edge of the woven layer was then tacked together to a leader fabric (a fabric used solely to bring another material through the needlepunch loom) for stability. The nonwoven fabric was fed to the needlepunch loom edge and the system of nonwoven and woven materials was fed into the needlepunch loom for consolidation of an intermediary material.

After the first pass through the loom was completed, the second woven layer was situated on the other face of the nonwoven layer. The layers were again tacked to a leader fabric and fed through the loom again. During this pass, the non-woven layer was consolidated between the two woven layers. Thus, the step of interposing or inserting a nonwoven layer between two woven layers included placing a nonwoven layer between woven layers on the loom.

The first pass through the needlepunch loom to attach the first woven layer to the non-woven layer was conducted at 600 penetration/sq. in. (93 penetrations/cm²) with a 4.0 mm penetration of needle into the materials. The type of needle used was a finishing needle. The machine was run at 1.7 yards/minute (1.6 m/min.). The intermediary material was then run through the loom a second time to attach the second woven layer to the nonwoven material. The second pass through the loom was conducted at 600 penetrations/sq. inch (93 penetrations/cm²) with a 4.0 mm penetration of needle into the materials. For this pass, the machine was run at 1.7 yards/minute (1.6 m/min.).

As a result of the needle punching process, the nonwoven layer was firmly interposed between the woven layers and the finished material to form an integral material without requiring assembly of individual layers. A rigid composite material was then molded from the integral material. In this example, an 11 inch by 18 inch sample of the integral material was treated with an epoxy resin. The epoxy resin was poured on the integral material, and spread to coat evenly the integral material with a squeegee-like tool. In this sample, 40% resin content was achieved meaning that 40% of the final weight of the material was resin.

After the resin was applied, the material was allowed to cure to a B-stage or intermediary stage composite in ambient temperature overnight. The following day, the B-stage or intermediary stage composite was pressed for 60 minutes at 350° F. and 15 psi in an 18 inch by 18 inch flat press to form a rigid composite. The rigid composite produced was tested for flame resistance, and extinguished from a 12 second vertical burn test with a 1550F flame in less than one second.

### EXAMPLE 2

An exemplary flexible composite material according to the invention was prepared by placing a fire resistant non-woven material (which may be manufactured, for example, by dry laid carding and mechanical needling) having an areal weight of about 3.0 oz./sq. yd. (101.7 g/m²) at the inlet side of a needlepunch loom on an automatic roll feed system timed to feed the fire resistant non-woven material at the same rate as the machine speed. The fire resistant non-woven material was situated on a layer of woven material on the inlet side of the needlepunch loom. The leading edge of the woven layer was then tacked to the leader fabric for stability. The fire resistant non-woven fabric was fed to the needlepunch loom edge and the entire system of non-woven and woven materials was fed into the needlepunch loom for consolidation.

The first pass through the needlepunch loom was conducted using a 600 penetration/sq. in. (93 penetrations/cm²) with an 4.0 mm penetration of needle into the materials. The type of needle used was a finishing needle. The machine was run at 2.8 yards/minute (2.6 m/min.). After the first pass, the material was run through the loom a second time. The second pass was to ensure that all of the woven layers were mechanically entangled in the z-direction with the nonwoven layer. The second pass through the loom was conducted at 600 penetrations/sq. inch (93 penetrations/cm²) with a 2.0 mm penetration of needle into the layers. During the second pass, the machine was run at 2.8 yards/minute (2.6 m/min.).

As a result of the needle punching process, the fire resistant nonwoven layer was firmly interposed or attached to the woven layer and the finished integral material was ready for use without requiring assembly of individual layers.

The integral material was then subjected to a molding process to form a fire resistant, flexible composite material. An 11 inch by 18 inch sample of the integral material was treated with an epoxy resin. The epoxy resin was poured on the integral material, and spread with a squeegee-like tool to coat evenly the material. A 40% resin content was achieved, meaning that 40% of the final weight of the material was resin. After the resin was applied, the material was allowed to cure to a B-stage or intermediary stage composite in ambient temperature overnight. The following day, the B-stage or intermediary stage composite was pressed for 60 minutes at 350° F. and 15 psi in an 18 inch by 18 inch flat press to form a flexible composite material. The flexible composite produced was tested for flame resistance, and extinguished from a 12 second vertical burn test with a 1550° F. flame in less than one second. Additionally, the flexible composite material produced was sufficiently flexible to enable wrapping the material around a 3 inch diameter core.

The foregoing examples and detailed description are not to be deemed limiting of the invention which is defined by the following claims. The invention is understood to encompass such obvious modifications thereof as would be apparent to those of ordinary skill in the art.

What is claimed is:

1. A method of making a composite material having a rigid structure comprising the steps of:
inserting at least one non-woven substrate layer having a first face and a second face in between at least a first woven substrate layer and at least a second woven substrate layer;
mechanically entangling a plurality of fibers of the non-woven substrate layer with a plurality of fibers of the first face of the first woven substrate layer and a plurality of fibers of the second face of the woven substrate layer to form an integral material;
molding the integral material into a rigid composite material.

2. The method of claim 1, wherein the molding step comprises:
impregnating the integral material with an impregnating resin to form an resin-impregnated integral material; and
treating the resin-impregnated integral material to form the rigid composite material.

3. The method of claim 2, wherein the step of impregnating comprises infusing the impregnating resin into the integral material to form the resin-impregnated integral material.

4. The method of claim 3, wherein the step of infusing the impregnating resin comprises pumping the impregnating resin into the integral material under vacuum.

5. The method of claim 3, wherein the step of infusing comprises applying heat to the impregnating resin and the integral material.

6. The method of claim 2, wherein the step of impregnating comprises applying at least once the impregnating resin to the integral material using an application selected from the group consisting of pouring the impregnating resin to cover the integral material, dipping the integral material into a bath of the impregnating resin to submerge the integral material, and coating the integral material to cover the integral material with the impregnating resin, and combinations thereof.

7. The method of claim 2, wherein the step of impregnating comprises pulling the integral material and the impregnating resin through a die.

8. The method of claim 2, wherein the step of impregnating comprises asserting pressure to force the impregnating resin to soak more deeply into the integral material.

9. The method of claim 2, wherein the step of treating the resin-impregnated integral material comprises curing the resin-impregnated integral material in a single stage to form the rigid composite material.

10. The method of claim 2, wherein the step of treating the resin-impregnated integral material comprises:
curing the resin-impregnated integral material to an intermediary stage to form an intermediary stage resin-impregnated integral material;
forming the intermediary stage resin-impregnated integral material into a shape; and
curing the shaped intermediary stage integral material to form the rigid composite material.

11. The method of claim 1, wherein the step of mechanically entangling further comprises needle punching.

12. The method of claim 2, further comprising adapting the impregnating resin for fire resistance.

13. A composite material having a rigid structure comprising
at least a first and a second woven substrate layer and at least one non-woven substrate layer having a first face and a second face, a plurality of fibers of the first face being attached to and mechanically entangled with a plurality of fibers of the first woven substrate layer and a plurality of fibers of the second face being attached to and mechanically entangled with a plurality of fibers of the second woven substrate layer, to form an integral material;
wherein the integral material is molded to form a rigid composite material.

14. The composite material of claim 13, wherein at least one of the woven substrate layers comprises a plurality of fibers of a type selected from the group consisting of an aramid, a fiberglass and a basalt.

15. The composite material of claim 13, wherein at least one of the woven substrate layers comprises at least two woven substrate layers woven into a single layer to form a double cloth.

16. The composite material of claim 13, wherein the non-woven substrate layer comprises a plurality of fibers of a type selected from the group consisting of an aramid, a pre-oxidated polyacrylonitrile, a BelCoTex®, a fiberglass, and a modacrylic.

17. The composite material of 13, wherein the non-woven substrate layer comprises a fiber blend of at least two different types of fibers.

18. The composite material of claim 13, wherein the nonwoven layer is mechanically entangled with the woven substrate layers by needle punching.

19. The composite material of claim 13, wherein the rigid composite does not delaminate when exposed to a temperature of at least 1550° F. at a minimum for up to 12 seconds.

20. The composite material of claim 13,
wherein the integral material is impregnated with a resin to form a resin-impregnated integral material; and
wherein the resin-impregnated integral material is treated to form the rigid composite material.

21. The composite material of claim 14, wherein the impregnating resin is adapted for fire resistance.

22. The composite material of claim 14, wherein the impregnating resin is selected from the group consisting of an acrylic resin, a polyester resin, a vinyl ester resin, a polyurethane resin, an epoxy resin, and a phenolic epoxy resin.

23. The composite material of claim 14, wherein the resin-impregnated integral material is treated by curing to form the rigid composite material.

24. A composite material having a flexible structure comprising
at least one woven substrate layer and at least one fire resistant non-woven substrate layer having a first face, the first face including a plurality of fibers being attached to and mechanically entangled with a plurality of fibers of the woven substrate layer to form an integral material;
wherein the woven substrate layer comprises an aramid; and
wherein the fire resistant non-woven substrate layer comprises a fiber blend; and
wherein the integral material is molded to form a fire resistant, flexible composite material.

25. The flexible composite material of claim 24 further comprising a fire resistant coating.

26. The flexible composite material of claim 24, wherein the fiber blend comprises at least one type of fiber selected from the group consisting of a pre-oxidated polyacrylonitrile, an aramid, a fiberglass, a BelCoTex®, and a modacrylic.

27. The flexible composite material of claim 24, wherein the flexible composite material has a flexibility such that the flexible composite material can be folded in on itself.

28. A structure for containment comprising:
a plurality of non-door panels wherein each non-door panel includes at least a first and a second woven substrate layer and at least one non-woven substrate layer having a first face and a second face, a plurality of fibers of the first face being attached to and mechanically entangled with a plurality of fibers of the first woven substrate layer and a plurality of fibers of the second face being attached to and mechanically entangled with a plurality of fibers of the second woven substrate layer, to form an integral non-door panel material;
wherein the integral non-door panel material is molded to form a rigid composite non-door panel;
a door panel including at least a woven substrate door panel layer and at least one non-woven substrate door panel layer having a first face, the first face including a plurality of fibers being attached to and mechanically entangled with a plurality of fibers of the woven substrate door panel layer to form an integral door panel material;
wherein the integral door panel material is molded to form a flexible composite door panel; and
wherein the rigid composite non-door panels and the flexible composite door panel are assembled to form a containment structure enclosing an interior space capable of being sealed and unsealed using the flexible composite door panel.

29. A structure for containment comprising:
a plurality of non-door panels wherein each non-door panel includes the rigid composite material of claim 13; and
a door panel including the flexible composite material of claim 24; and
wherein the non-door panel and the door panel are assembled to form a containment structure enclosing an interior space capable of being sealed and unsealed using the door panel.
